(19) United States
(12) Patent Application Publication
(10) Pub. No.: US 2002/0086173 A1
(43) Pub. Date: Jul. 4, 2002

(54) Polyvinyl acetate coating for strength improvement in a gypsum containing board

(76) Inventors: Joseph A. Yosick, Northbrook, IL (US); D. Paul Miller, Lindenhurst, IL (US)

Correspondence Address: Glenn W. Ohlson, Lee, Mann, Smith, McWilliams, Sweeney & Ohlson, P. O. Box 2786, Chicago, IL, 60690-2786, US

(21) Appl. No.: 09/751,056

(22) Filed: Dec. 29, 2000

(51) Int. Cl. B32B 23/08

(52) U.S. Cl. 428/507; 428/175; 428/500

(57) ABSTRACT

A construction material, particularly a gypsum containing board, where said board has a coating of polyvinyl acetate. In some embodiments, the coating is only on the exterior surface. In other embodiments the polyvinyl acetate penetrates below the surface of the product where it bonds with materials in the interior, as well as forming a coating on the exterior surface. The specification also discloses methods for applying an emulsified polyvinyl acetate to the exterior surface of a board to create such a coated product.

### FIELD OF THE INVENTION

This invention generally relates to the field of building materials, more particularly, gypsum containing products, such as gypsum containing wallboards.

### BACKGROUND OF THE INVENTION

Gypsum baseboard products have become very useful in a wide variety of applications. Not only have boards utilizing gypsum alone become useful, but boards containing both gypsum and other materials such as wood fiber have been developed and have exhibited advantages over gypsum board in certain applications. One such material is gypsum wood fiber board (GWF) as taught in U.S. Pat. No. 5,320,677 assigned to United States Gypsum and incorporated herein by reference in its entirety. Despite a gypsum wood fiber board's many advantages and increased strength over gypsum board, further increases in strength and durability are desired. Particularly, a board, which has improved abuse resistance and impact resistance, is sought.

To that end, researchers have attempted to add various materials to the gypsum slurry used to manufacture the gypsum board, prior to the formation of the gypsum board. It has been known to add polyvinyl acetate (PVAc) to plaster prior to molding to improve the plaster's molding characteristics as taught in U.S. Pat. No. 5,441,585 to Rodda. The inventors herein have previously tried to add PVAc to the gypsum slurry mix when forming a gypsum board. It was discovered, however, that adding PVAc directly to the slurry resulted in clogged screens or forming wires due to the coagulation of the PVAc in the slurry. Further, such addition of PVAc into the slurry results in a board product having PVAc distributed throughout the product, which results in a waste of PVAc as the PVAc is needed only at or near the surface of the product to achieve the desired increase in strength, impact resistance, and durability. Thus, the invention herein described is a product having PVAc applied to the exterior surface of the product. Although the PVAc may soak or penetrate into the product to a limited extent, it is desired that the PVAC remain on the exterior surface. The extent of absorption will depend upon the product and its composition. The absorbed PVAc may bond with the materials comprising the product's core, particularly where the core includes wood, paper, or other cellulosic fibers, thereby providing improved bonding of the PVAc coating on the exterior surface as well as improving the durability, impact resistance, and fluxural strength of the product. Absorption however, is not required to obtain the desired increase in strength, durability, and fluxural strength, as a surface coat may be all that is required or even possible, given the characteristics of the material. For instance, if the material is non-porous, the PVAc is unlikely to soak into the material in any appreciable amount and will remain, for the most part, on the surface, thereby forming a surface coat. In instances where a more porous material is used, the opposite may be true, that is more PVAc may soak into the material, although the application of multiple coats of PVAc may allow for both high absorption and an appreciable surface coating.

This disclosure further teaches the method of applying the PVAc to the board. The methods disclosed herein may be used with any gypsum containing product or board, although it is most particularly applied to a GWF board. One will recognize that the application of PVAc need not be limited to a gypsum containing product or to a board, but may also be applied to a wide variety of products with a wide variety of compositions, as previously discussed. The invention may be applied to other materials, such as cementious board, mineral fiber tiles, masonite-type hardboard, oriented strand board, medium density fiber board, or particle board, and need not be limited to gypsum containing products. Also, the invention need not be strictly applied to board products, but may be applied to any shaped product.

### SUMMARY OF THE INVENTION

The PVAc may be applied to any gypsum containing product, particularly construction materials, as one skilled in the art would recognize. Herein, the PVAc will be described as applied to a board product, most particularly, a GWF board product. The present invention is directed to a product having PVAc on its exterior surface and a method for applying PVAc to a product such as a cellulose/gypsum based substrate, and in particular, the use of one or more rotary cylinder brushes to provide a uniform application of pMDI onto the cellulose/gypsum based substrate.

Gypsum boards are typically manufactured by a process as described in U.S. Pat. No. 5,320,677. The process involves placing a gypsum slurry on a wire mesh conveyor or forming wire and removing water by the application of a vacuum from below. The board is also shaped and further dewatered by the application of pressure by roller presses. The resulting board product typically has a smooth finish face, and a rougher face, which was against the wire mesh during the manufacturing process. Because it rests upon the wire mesh as a vacuum is applied from below, the rougher face is imprinted with the texture of the wire mesh. Although the application of PVAc could be applied to either face, the application works particularly well on the rougher face. The textured surface or relief formed by the wire mesh on the back surface of the board permits good penetration of the PVAc into the board, and improves the adherence of the coating.

The apparatus selected to apply the PVAc may vary. For instance, the PVAc may be applied with a brush or roller by a worker. This method of applying the PVAc may be good for one-off molded products, but would not be practical for an assembly line or products produced in high volume, such as gypsum containing wall board. A more practical means of application would be to use spraying, roller coating, or roller brushing machinery to apply the PVAc as the board is carried past the coating apparatus on a conveyor.

One disadvantage of using machinery is that the PVAc is sticky and tends to clog and foul the apparatus. However, with use of an emulsion, the clogging and fouling problems can be reduced. An example of such an emulsion of PVAc is Vinac 1000 manufactured by Air Products and Chemicals, Inc. of Allentown, Pa., which is a crosslinked polyvinyl acetate homopolymer emulsion having 52% solids. Other emulsions may be used, even those not formulated as adhesives.

In instances where a brush or roller coater is used to apply the PVAC to the face of the board, the need to emulsify the PVAc is reduced as compared to a spraying apparatus, as the brush and roller coater are not as prone to clogging as the spraying apparatus. However, The PVAc will still be sticky if not emulsified and it may degrade the performance of the brush or roller coater, as well as affect other aspects of the system, such as the conveyor. Therefore, performance of the application apparatus may be improved, and down time or maintenance decreased, by the use of PVAc in an emulsion.

In a typical application, the dried board is placed textured side up on a conveyor apparatus, such as a wire mesh similar to that used in the process of forming the board, and well known to those skilled in the art. The conveyor apparatus transports the board to an application area where the apparatus for applying the PVAc is stationed. The application area may include an apparatus such as a sprayer, brush coater, roller coater, or any other apparatus known in the art to apply liquids to products. Once the PVAc is applied to the board, the board is carried by conveyor to a drying area, where the PVAc is allowed to dry. The drying may be enhanced by known methods, such as warm air or infrared heat. The board may then be sent to the same application area or an additional application area for an additional coating of PVAc, or in the alternative, if the desired application of PVAc has been achieved, packaged for shipment. Multiple applications of PVAc may be carried out on the same product, but it is preferable to dry each application prior to applying an additional amount so as not to disrupt the semi-dry coat.

The PVAc is typically applied in coating weights between 60 lbs. per thousand square feet (msf) to 115 lbs. per msf. These coating weights result from a dosage on a dry solids/dry solids basis of 1.21% and 2.31% respectively. Such application concentrations increase flexural strength of a GWF panel by 5% and 60% respectively. As further examples, dosages of 1.5% and 2.6% increase the flexural strength by approximately 10% and 15-30% respectively.

### BRIEF DESCRIPTION OF THE DRAWINGS

FIG. 1 is an illustration of a manufacturing line using a rotary brush.

FIG. 2 is a cross-sectional view of a coated board using a scrim.

### DETAILED DESCRIPTION OF THE PREFERRED EMBODIMENT

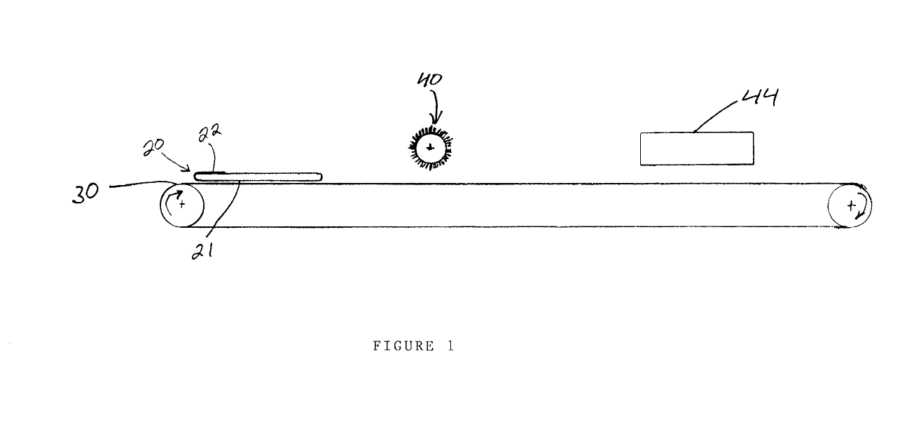

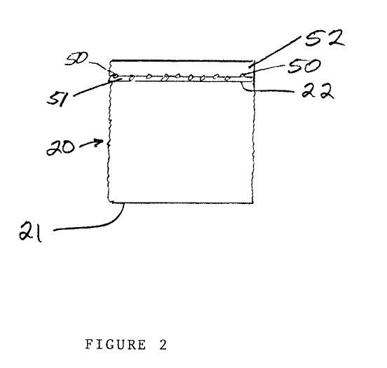

In the preferred embodiment, a gypsum wood fiber board 20 is provided with a coating of polyvinyl acetate on at least one of its surfaces. With reference to FIGS. 1 and 2, the gypsum wood fiber board 20 generally has a finish face 21 and a back face 22. The back face 22 may have texture imparted to it as a result of the process used to manufacture the board, but such texture is not required.

With reference to FIG. 1, the board 20 is placed upon a conveyor 30, back face 22 up, for transportation to an application apparatus, which applies the PVAc to the back face 22 of the board 20. The application is preferably accomplished by a roller brush 40 having bristles about its circumference. The PVAc emulsion is applied to the bristles and the brush rotates placing the bristles into contact with the back face 22 of the gypsum wood fiber board 20 as the board is carried by the conveyor 30 past the roller brush 40, thus transferring the PVAc to the back face 22 of the board.

After application of the PVAc, the conveyor carries the gypsum wood fiber board 20 to a drying area where the coating is dried. The drying may be assisted by infrared heat from a heat lamp or coil 44, or other means known in the art, such as the movement of ambient or heated air. If the board 20 is not sufficiently coated, it may be returned to the beginning of the conveyor 30 for another subsequent application of PVAc. Alternately, the board 20 may be delivered to another PVAc coating apparatus for its second and subsequent coats.

If additional strength is desired, the board 20 may have a scrim 50 applied to the back face 22, as shown in cross section in FIG. 2. The scrim 50 is preferably a fiberglass mesh having a mesh size of one-quarter inch (¼″). It is preferred that scrims of other materials and mesh sizes may be used, as the desired product dictates. The scrim 50 is applied to the rear face 22 of the board 20 subsequent to the application of a first coat 51 of PVAc, but prior to the PVAc drying. The application of the first coat 51 of PVAc prior to applying the scrim 50 allows the board 20 to achieve tack to adhere the scrim 50 to the board 20. A second coat 52 of PVAC is applied after the initial tack coat is dried to embed the scrim 50. Additionally, subsequent coats of PVAc may be applied until the desired coating is obtained. In the alternative, the scrim 50 may be placed on the board 20 prior to the applications of any PVAc.

It is preferred that the polyvinyl acetate applied to the board 20 is a cross linked polyvinyl acetate homopolymer emulsion, such as Vinac 1000 manufactured by Air Products and Chemicals, Inc. of Allentown, Pa., although other emulsions may be used.

The PVAc is applied to result in a final coating weight between 60 lbs. per mfs to 115 lbs. mfs. These coating weights result from a dosage on a dry solids to dry solids basis of 1.21% and 2.31% respectively. These dosages result in increased structural strengths of the gypsum wood fiber board by 5% and 60% respectively. Thus, the PVAc may be applied in dosages sufficient to reach these figures in one coat, or in multiple coats.

Various features of the invention have been particularly shown and described in connection with the illustrated embodiments of the invention. However, it must be understood that these particular arrangements, and their method of manufacture, do not limit but merely illustrate, and that the invention is to be given its fullest interpretation within the terms of the appended claims.

What is claimed is:

1. A gypsum containing construction material including an exterior coating of emulsified polyvinyl acetate.

2. The product of claim 1, wherein the construction material is a board.

3. The construction material of claim 1, where the product includes cellulosic fibers.

4. The construction material of claim 3, where the product is a board having a core including cellulosic fibers, said emulsified polyvinyl acetate penetrating said core to form bonds with said cellulosic fibers.

5. A gypsum containing board, said board having a first face and a second face, at least one of said faces having a coating of emulsified polyvinyl acetate.

6. The board as claimed in claim 5, where said board also contains cellulosic fibers.

7. The board of claim 5, at least one of said faces having a scrim attached thereto.

8. The board of claim 7, where said scrim is embedded in the coating of polyvinyl acetate.

9. The board of claim 7, where said scrim is a fiberglass mesh.

10. The board of claim 5 wherein the emulsified polyvinyl acetate has a coating weight at between 60 and 115 pounds per thousand square feet of board.

11. The board of claim 5 wherein the emulsified polyvinyl acetate has a coating weight of at least 60 pounds per thousand square feet of board.

12. The board of claim 5 where the emulsified polyvinyl acetate has a dosage on a dry solids to dry solids basis of 1.21% to 2.31%.

13. The board of claim 5 wherein the emulsified polyvinyl acetate has a dosage on a dry solids to dry solids basis of at least 1.21%.

14. The board of claim 5 where said board has a 5% to 60% increase in flexural strength as compared to an uncoated board.

15. A method of producing a polyvinyl acetate coated gypsum containing board, including the steps of:
providing a gypsum containing board having at least one exterior surface;
applying an emulsified polyvinyl acetate to said exterior surface;
said emulsified polyvinyl acetate thereby forming a coating on said exterior surface.

16. The method as claimed in claim 15, where said drying includes the application of heat.

17. The method as claimed in claim 15, further including the step of applying a scrim to said surface of said board.

18. The method of claim 15, where said emulsified polyvinyl acetate is applied by spraying emulsified polyvinyl acetate onto said exterior surface of said board.

19. The method of claim 15, where said emulsified polyvinyl acetate is applied by a roller coater onto said exterior surface of said board.

20. The method of claim 15, where said emulsified polyvinyl acetate is applied by a roller brush.

21. The method of claim 15, where said emulsified polyvinyl acetate is applied at a dosage of at least 1.21% on a dry solids to dry solids basis.
